(19) United States
(12) Patent Application Publication
(10) Pub. No.: US 2008/0141803 A1
(43) Pub. Date: Jun. 19, 2008

(54) Electromechanical linear actuator including an environmental control and air management system

(75) Inventors: Donald J. Christensen, Phoenix, AZ (US); Don L. Mittendorf, Mesa, AZ (US); Adam Q. Tejada, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/588,688

(22) Filed: Oct. 26, 2006

(51) Int. Cl. F16H 27/02

(52) U.S. Cl. 74/89.4

(57) ABSTRACT

An actuator that at least inhibits the deleterious effects of corrosive fluids, such as salt-laden air, does not rely on relatively expensive materials. At least a portion of the actuator housing is sealed from the surrounding salt-laden air, and is in fluid communication with an air reservoir that includes a supply of relatively salt-free, or substantially salt-free, air. The actuator is configured to exchange air between the air reservoir and the actuator housing, thereby at least substantially inhibiting the ingress of salt-laden air into much of the actuator.

### TECHNICAL FIELD

The present invention relates to linear actuators and, more particularly, to an linear actuator that includes a seal system for isolating at least portions of the actuator from a corrosive fluid, such as seawater.

### BACKGROUND

Actuators are used in myriad devices and systems. For example, many vehicles including, for example, aircraft, spacecraft, watercraft, and numerous other terrestrial and non-terrestrial vehicles, include one or more actuators to effect the movement of various components. In many applications such as, for example, in seagoing watercraft, the actuators that are used may be subject to corrosive fluid. For example, many seagoing watercraft include actuators that may be at least partially exposed to the corrosive salt-laden air environment. To prevent or at least inhibit the corrosive effects of salt-laden sea air, actuators may be constructed, at least partially, of various corrosion resistant materials. These materials, however, can be relatively expensive, and thus can increase actuator costs and, concomitantly, overall system and/or vehicle costs.

Hence, there is a need for a system that at least inhibits the deleterious effects of corrosive fluids on an actuator that does not rely on one or more relatively expensive materials. The present invention addresses at least this need.

### BRIEF SUMMARY

In one embodiment, and by way of example only, an actuation system includes an actuator housing, a translation member, a seal, and an air reservoir. The actuator housing has at least a first end, a second end, and an inner surface that defines an inner volume. The actuator housing second end has an opening therein. The translation member is disposed at least partially within the actuator housing volume, and is movable at least partially into and out of the actuator housing via the opening in the actuator housing second end. The translation member is adapted to receive a drive force and is operable, upon receipt thereof, to translate in either a first direction or a second direction. The seal is disposed between, and is in contact with, the actuator housing inner surface and the translation member. The seal is configured to translate within the actuator housing whenever the translation member translates. The air reservoir is in fluid communication with the actuator housing inner volume between the seal and the actuator housing first end.

In another exemplary embodiment, an actuation system includes an actuator housing, an actuation member, a translation member, a seal, and an air reservoir. The actuator housing has at least a first end, a second end, and an inner surface that defines an inner volume. The actuator housing second end has an opening therein. The actuation member is disposed within the actuator housing inner volume, is adapted to receive a rotational input force, and is operable, upon receipt of the rotational input force, to supply a drive force. The translation member is disposed at least partially within the actuator housing volume, and is movable at least partially into and out of the actuator housing via the opening in the actuator housing second end. The translation member is coupled to receive the drive force from the actuation member and is operable, upon receipt thereof, to translate in either a first direction or a second direction. The seal is disposed between, and is in contact with, the actuator housing inner surface and the translation member. The seal is configured to translate within the actuator housing whenever the translation member translates. The air reservoir is in fluid communication with the actuator housing inner volume between the seal and the actuator housing first end.

In yet another exemplary embodiment, an actuation system includes an actuator housing, an actuation member, a translation member, a seal, an air reservoir, and a conduit. The actuator housing has at least a first end, a second end, and an inner surface that defines an inner volume. The actuator housing second end has an opening therein. The actuation member is disposed within the actuator housing inner volume, is adapted to receive a rotational input force, and is operable, upon receipt of the rotational input force, to supply a drive force. The translation member is disposed at least partially within the actuator housing volume, and is movable at least partially into and out of the actuator housing via the opening in the actuator housing second end. The translation member is coupled to receive the drive force from the actuation member and is operable, upon receipt thereof, to translate in either a first direction or a second direction. The seal is disposed between, and is in contact with, the actuator housing inner surface and the translation member. The seal is configured to translate within the actuator housing whenever the translation member translates. The air reservoir is in fluid communication with the actuator housing inner volume between the seal and the actuator housing first end. The conduit is coupled to, and provides fluid communication between, the air reservoir and the actuator housing inner volume.

Other independent features and advantages of the preferred actuation system will become apparent from the following detailed description, taken in conjunction with the accompanying drawings which illustrate, by way of example, the principles of the invention.

### BRIEF DESCRIPTION OF THE DRAWINGS

FIG. 1 is a partial cross section view of an exemplary actuator according to an embodiment of the present invention;

FIG. 2 is a partial cross section view of the exemplary actuator depicted in FIG. 1 coupled to a particular exemplary air reservoir;

FIG. 3 is a partial cross section view of the exemplary actuator depicted in FIG. 1 coupled to another particular exemplary air reservoir; and

FIG. 4 is a partial cross section view of the exemplary actuator depicted in FIG. 1 coupled to yet another particular exemplary air reservoir.

### DETAILED DESCRIPTION OF A PREFERRED EMBODIMENT

The following detailed description is merely exemplary in nature and is not intended to limit the invention or the application and uses of the invention. Furthermore, there is no intention to be bound by any theory presented in the preceding background or the following detailed description.

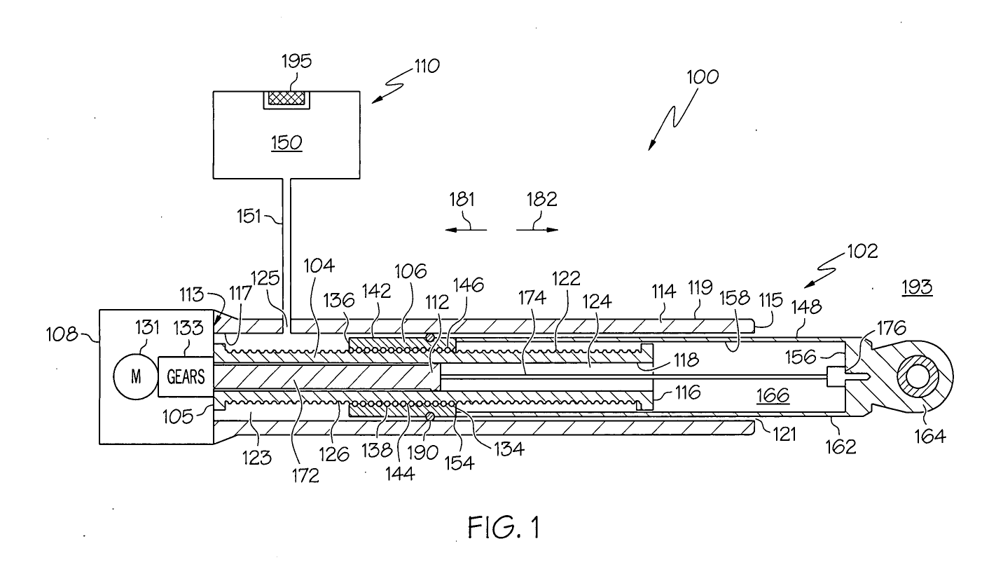

Referring to FIG. 1, a cross section view of an exemplary actuator system 100 is depicted. The depicted actuator system 100 includes an actuator 102 and an air reservoir 110. The actuator 102 is preferably a linear electromechanical (EMA) actuator and includes an actuation member 104, a translation member 106, a motor and gear assembly 108, and a position sensor 112, all disposed at least partially within or on an actuator housing 114. The actuator housing 114 includes a first end 113, a second end 115, an inner surface 117, and an outer surface 119. The actuator housing first end 113 is coupled to the motor and gear assembly 108, and the actuator housing second end 115 has an opening 121 therein through which the translation member 106 extends. The actuator housing inner surface 117 defines an inner volume 123 within which the actuation member 104 is disposed, and the translation member 106 is at least partially disposed. The actuator housing 114 further includes an air exchange opening 125 that extends between the actuator housing inner and outer surfaces 117, 119. As FIG. 1 depicts, the actuator housing inner volume 123 is in fluid communication with the fluid reservoir 110 via the air exchange opening 125.

The actuation member 104 is preferably implemented as a ballscrew, and is rotationally mounted within the actuator housing assembly 112. The actuation member 104 includes a first end 114, a second end 116, an inner surface 118, and an outer surface 122. The actuation member inner surface 118 defines a substantially cylindrical sensor passageway 124 that extends at least partially through the actuation member 104. The actuation member outer surface 122 has one or more ball grooves (or “threads”) 126 formed thereon. The actuation member 104 receives a rotational drive force from the motor and gear assembly 108, which causes the actuation member 104 to rotate.

The translation member 106 is preferably implemented as a ballnut, and is disposed at least partially around the actuation member 104. The translation member 106, similar to the actuation member 104, includes a first end 134, a second end 136, an inner surface 138, and an outer surface 142. The translation member 106 is mounted against rotation within the actuator housing 114 and is configured, in response to rotation of the actuation member 104, to translate axially within the actuator housing 114 in either a first direction 181 or a second direction 182. The translation member 106, similar to the actuation member 104, has one or more ball grooves (or “threads”) 144 formed therein. A plurality of recirculating balls 146 are disposed within the ballnut ball grooves 144, and in selected ones of the actuation member ball grooves 126. The balls 146, in combination with the ball grooves 126, 144, convert the rotational movement of the actuation member 104 into the translational movement of the translation member 106. It will be appreciated that the direction in which the translation member 106 travels will depend on the direction in which the actuation member 104 rotates.

The translation member 106 also preferably includes an extension tube 148 that extends through the opening 121 in the actuator housing 114. The extension tube 148 includes a first end 154, a second end 156, an inner surface 158, and an outer surface 162. The extension tube first end 154 is disposed within the actuator housing 114, whereas the extension tube second end 156 is disposed external thereto and has a rod end assembly 164 coupled thereto. The rod end assembly 164 is configured to couple the extension tube 148 to a component (not shown) so that the actuator 102 can move the component to a position commanded by, for example, a non-illustrated actuator controller. The extension tube inner surface 158 forms a cavity 166, and the extension tube outer surface 162 is mounted against rotation within the actuator housing assembly 112. This may be implemented using any one of numerous types of anti-rotation mounting configurations. For example, the extension tube outer surface 162 could have a groove or slot formed therein in which a section of the actuator housing 114 is inserted.

The motor and gear assembly 108 preferably includes an electric motor 131 and one or more gears 133. The motor 131 is preferably a brushless DC motor, though it will be appreciated that it could be implemented using any one of numerous other DC or AC motors. No matter the particular motor type, the motor 131 is appropriately energized via, for example, the previously mentioned actuator controller to rotate and supply a rotational input force, via the gears 133, to the ballscrew 104. The direction in which the motor 131 rotates, determines the direction in which the actuation member 104 rotates, which in turn determines in which direction the translation member 106 tranlsates.

The position sensor 112 is disposed at least partially within the ballscrew 104 and is additionally coupled to the extension tube 148. More specifically, in the depicted embodiment the position sensor 112 is implemented as a linear variable differential transformer (LVDT) that includes a differential transformer (not shown) disposed within a sensor housing 172, and a movable slug 174. The sensor housing 172 is coupled to the actuator housing 114 and extends into the sensor passageway 124 formed in the ballscrew 104. The movable slug 174 is coupled to the extension tube 148, via a slug mount 176 that is formed on the extension tube inner surface 158, and is movably disposed within, and extends from, the sensor housing 174.

The differential transformer, as is generally known, includes at least a non-illustrated primary winding, and a non-illustrated differentially wound secondary winding. The transformer primary winding is energized with an AC signal supplied from, for example, the controller via the sensor connector, and the secondary winding supplies a position signal representative of the position of the movable slug 174 to, for example, the controller via the sensor connector. Because the movable slug 174 is coupled to the extension tube 148, the movable slug 174 translates whenever the translation member 106 translates. Thus, the position signal supplied from the secondary winding is representative of the position of the translation member 106, which may in turn be correlated to the position of the element to which the actuator 100 is coupled.

It will be appreciated that an LVDT is merely exemplary of a particular preferred position sensor 112, and that the position sensor 112 may be implemented using any one of numerous other sensing devices now known, or developed in the future. Examples of alternative position sensors include, but are not limited to, a rotary variable differential transformer (RVDT), a potentiometer, a resolver, one or more Hall sensors, and one or more optic sensors.

As FIG. 1 additionally depicts, the actuator 100 further includes a seal 190. The seal 190 is disposed between, and is in contact with, the actuator housing inner surface 117 and the translation member 106, and is configured to translate within the actuator housing 114 whenever the translation member 106 translates. Although the seal 190 could be disposed between the actuator housing 114 and the translation member 106 in any one of numerous ways and in any one of numerous locations, it is preferably disposed within a groove formed in the translation member 106. Thus, whenever the translation member 106 translates in either the first 181 or second 182 directions, the seal 190 concomitantly translates in the first 181 and second 182 directions. It will be appreciated that the seal 190 may be implemented using any one of numerous types of seals, but in a particular preferred embodiment the seal 190 is implemented using a piston seal. It will additionally be appreciated that the seal 190, if implemented as a piston seal, may be any one of numerous types of piston seals.

No matter the specific type of seal 190 that is used, the seal 190 is configured to provide at least a substantially air-tight seal between the environment 193 external to the actuator 100 and the actuator housing inner volume 123 between the seal 190 and the actuator housing first end 113. It will thus be appreciated that the actuator 102 additionally acts as an air pump, pumping air into and out of at least a portion of the actuator housing inner volume 123 via the air exchange opening 125. The air that is pumped into and out of the actuator housing inner volume 123 is preferably salt-free, or at least substantially salt-free, air that is drawn from or returned to, respectively, the air reservoir 110.

The air reservoir 110 may be implemented in accordance with any one of numerous configurations, and using any one of numerous components and devices. For example, in the embodiment depicted in FIG. 1, the air reservoir 110 is a compartment 150 that is disposed remote from the actuator 102, and has a volume of air disposed therein. A conduit 151 is coupled to the actuator housing air exchange opening 125 and the compartment 150, and provides fluid communication between the compartment 150 and the actuator housing inner volume 123. The compartment 150 may be, for example, a personnel compartment within the vehicle in which the actuator system 100 is installed. Preferably, the compartment 150 is selected such that the volume of air that is within the compartment 150, and that is thus exchanged with the actuator inner volume 123, is at least substantially salt-free.

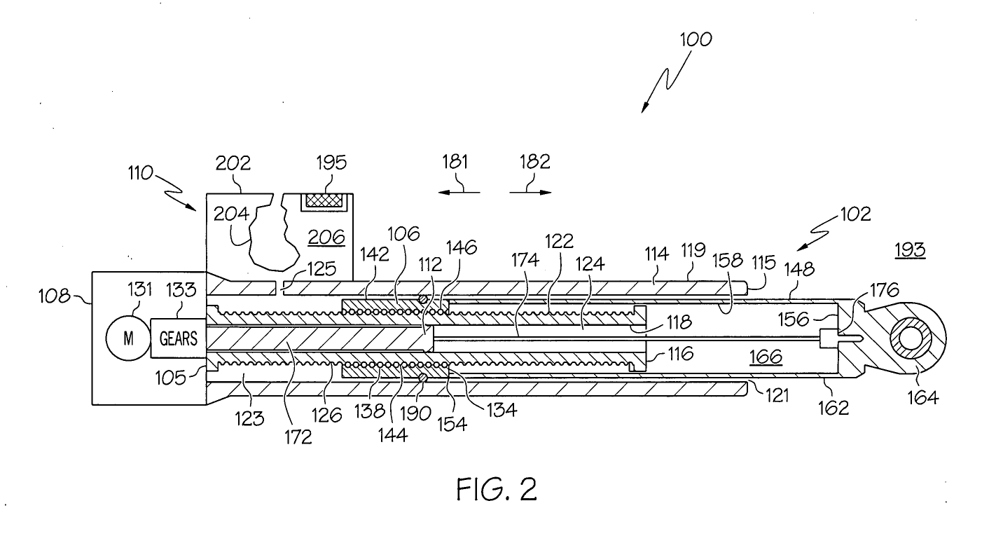

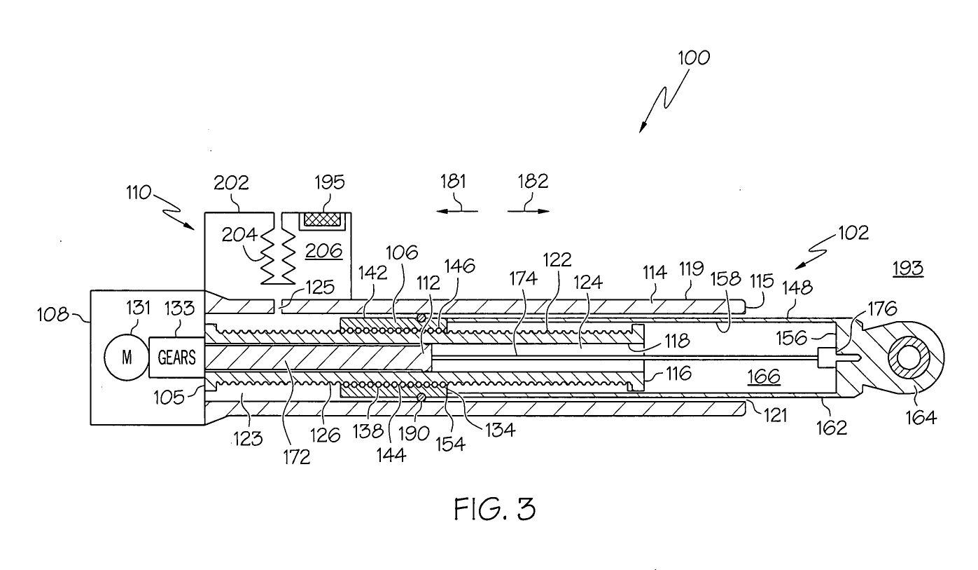

In other embodiments, which are depicted in FIGS. 2-4, the air reservoir 110 is configured as an expandable reservoir, and may be disposed remote from the actuator 102 or, as depicted in FIGS. 2-4, mounted on the actuator 102. It will be appreciated that the actuation system 100 could, but need not include, the conduit 151 if the air reservoir 110 is mounted on the actuator 102. In either case, the expandable air reservoir 110, in the embodiments depicted in FIGS. 2 and 3, includes a containment vessel 202 and an expandable member 204. The containment vessel 202 has an inner volume 206 that is in fluid communication with the actuator housing inner volume 123, thus facilitating the flow of air between these two volumes 123, 206. The expandable member 204 is coupled to the containment vessel 202 and is disposed within the containment vessel inner volume 206. The expandable member 204 expands and contracts as air is drawn from and supplied to the containment vessel inner volume 206, and is thus respectively supplied to and drawn from the actuator housing inner volume xxx. The expandable member 204 is depicted as a flexible bladder in FIG. 2, and as a bellows is FIG. 3. It will be appreciated, however, that this is merely exemplary, and that the expandable member 204 may be implemented using any one of numerous other suitable devices.

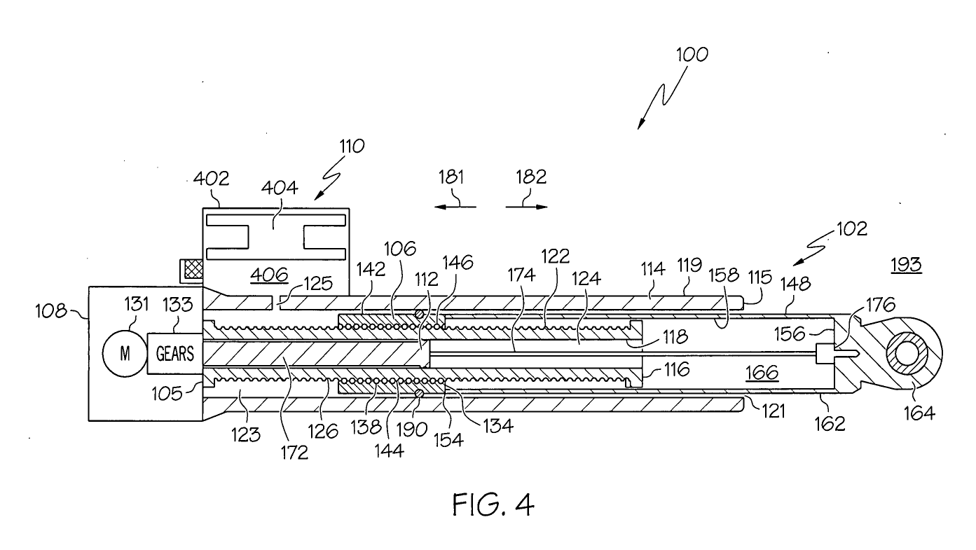

In addition to being implemented using the above-described containment vessel 202 and expandable member 204, the air reservoir 110 could also be implemented using a piston/housing arrangements. For example, and as shown in FIG. 4, the air reservoir 110 could include a piston housing 402 and a piston 404. In this embodiment, the piston housing 402 includes an inner volume 406 that that is in fluid communication with the actuator housing inner volume 123. The piston 404 is movably disposed within the piston housing inner volume 406 and moves therein as air is drawn from and supplied to the piston housing inner volume 406, and is thus respectively supplied to and drawn from the actuator housing inner volume 123.

As FIGS. 1-4 each depict, the actuation system 100 also preferably includes one or more desiccant filters 195. The desiccant filters 195 could be disposed in any one of numerous locations within the system 100 such that the filters 195 are in fluid communication with the actuator housing inner volume 123. With this configuration, the desiccant filters 195 will absorb any moisture that may enter the actuator housing inner volume 123 between the seal 190 and the actuator housing first end 113. Preferably, the desiccant filters 195 are disposed in a location that is readily accessible for ease of replacement. Moreover, the desiccant filters 190 also preferably provide visual indication of the presence of moisture and/or the need of replacement.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. An actuation system, comprising:
an actuator housing having at least a first end, a second end, and an inner surface that defines an inner volume, the actuator housing second end having an opening therein;
a translation member disposed at least partially within the actuator housing volume, and movable at least partially into and out of the actuator housing via the opening in the actuator housing second end, the translation member adapted to receive a drive force and operable, upon receipt thereof, to translate in either a first direction or a second direction;
a seal disposed between, and in contact with, the actuator housing inner surface and the translation member, the seal configured to translate within the actuator housing whenever the translation member translates; and
an air reservoir in fluid communication with the actuator housing inner volume between the seal and the actuator housing first end.

2. The actuation system of claim 1, further comprising:
a conduit coupled to, and providing fluid communication between, the air reservoir and the actuator housing inner volume.

3. The actuation system of claim 1, wherein the air reservoir is configured as an expandable air reservoir.

4. The actuation system of claim 3, wherein the air reservoir comprises:
a containment vessel having an inner volume in fluid communication with the actuator housing inner volume; and
an expandable member coupled to the containment vessel and disposed within the containment vessel inner volume.

5. The actuation system of claim 4, wherein the expandable member comprises a bladder.

6. The actuation system of claim 4, wherein the expandable member comprises a bellows.

7. The actuation system of claim 3, wherein the air reservoir comprises:
a piston housing having an inner volume in fluid communication with the actuator housing inner volume; and
a piston movably disposed within the piston housing.

8. The actuation system of claim 1, wherein the air reservoir is coupled to the actuator housing.

9. The actuation system of claim 1, wherein the air reservoir comprises:
a compartment disposed remote from the actuator housing, the compartment having a volume of air therein.

10. The actuation system of claim 9, further comprising:
a conduit coupled between, and fluidly communicating, the compartment volume and the actuator housing inner volume.

11. The actuation system of claim 1, further comprising:
a desiccant filter in fluid communication with the housing inner volume.

12. The actuation system of claim 1, wherein the seal comprises a piston seal.

13. The actuation system of claim 1, further comprising:
an actuation member adapted to receive a rotational input force and operable, upon receipt thereof, to supply the drive force to the translation member.

14. The actuation system of claim 13, further comprising:
a motor coupled to the actuation member and operable to selectively supply the rotational drive force to thereto.

15. The actuation system of claim 13, wherein:
the actuation member comprises a ballscrew;
the translation member comprises a ballnut that surrounds at least a portion of the ballscrew; and
the seal contacts, and translates with, the ballnut.

16. The actuation system of claim 15, wherein the translation member further comprises an extension tube coupled to the ballnut.

17. An actuation system, comprising:
an actuator housing having at least a first end, a second end, and an inner surface that defines an inner volume, the actuator housing second end having an opening therein;
an actuation member disposed within the actuator housing inner volume, the actuation member adapted to receive a rotational input force and operable, upon receipt thereof, to supply a drive force;
a translation member disposed at least partially within the actuator housing volume, and movable at least partially into and out of the actuator housing via the opening in the actuator housing second end, the translation member coupled to receive the drive force from the actuation member and operable, upon receipt thereof, to translate in either a first direction or a second direction;
a seal disposed between, and in contact with, the actuator housing inner surface and the translation member, the seal configured to translate within the actuator housing whenever the translation member translates; and
an air reservoir in fluid communication with the actuator housing inner volume between the seal and the actuator housing first end.

18. The actuation system of claim 17, further comprising:
a conduit coupled to, and providing fluid communication between, the air reservoir and the actuator housing inner volume.

19. The actuation system of claim 17, further comprising:
a desiccant filter in fluid communication with the housing inner volume.

20. An actuation system, comprising:
an actuator housing having at least a first end, a second end, and an inner surface that defines an inner volume, the actuator housing second end having an opening therein;
an actuation member disposed within the actuator housing inner volume, the actuation member adapted to receive a rotational input force and operable, upon receipt thereof, to supply a drive force;
a translation member disposed at least partially within the actuator housing volume, and movable at least partially into and out of the actuator housing via the opening in the actuator housing second end, the translation member coupled to receive the drive force from the actuation member and operable, upon receipt thereof, to translate in either a first direction or a second direction;
a seal disposed between, and in contact with, the actuator housing inner surface and the translation member, the seal configured to translate within the actuator housing whenever the translation member translates;
an air reservoir in fluid communication with the actuator housing inner volume between the seal and the actuator housing first end; and
a conduit coupled to, and providing fluid communication between, the air reservoir and the actuator housing inner volume.
